(19) United States
(12) Patent Application Publication
(10) Pub. No.: US 2019/0121040 A1
(43) Pub. Date: Apr. 25, 2019

(54) OPTICAL TRANSCEIVER

(71) Applicant: Prime World International Holdings Ltd., New Taipei City (TW)

(72) Inventor: Huan-Yu LIN, New Taipei City (TW)

(21) Appl. No.: 15/792,013

(22) Filed: Oct. 24, 2017

(51) Int. Cl. G02B 6/42; G02B 6/38

(52) U.S. Cl. CPC G02B 6/4292; G02B 6/4249; G02B 6/4246; G02B 6/4257; G02B 6/3885

(57) ABSTRACT

An optical transceiver includes a substrate, a housing, a ferrule and a fixture. The housing is disposed on an outer surface of the substrate and includes a pressed portion and an inset portion connected to each other. The pressed portion defines a first pressed surface, and the ferrule is disposed on the inset portion. The fixture is disposed on the housing, a first pressing surface of the fixture is pressed against the first pressed surface of the housing, and a second pressing surface of the fixture is pressed against a second pressed surface of the ferrule. The fixture detached from the housing is in a force-free condition, and a distance between the first pressing surface and the second pressing surface in the force-free condition is smaller than a distance between the first pressed surface and the second pressed surface.

### TECHNICAL FIELD

The present disclosure relates to an optical transceiver, more particularly to an optical transceiver accommodating a ferrule.

### BACKGROUND

Optical transceivers are generally installed in electronic communication facilities in modern high-speed communication networks. In order to make flexible the design of an electronic communication facility and less burdensome the maintenance of the same, an optical transceiver is inserted into a corresponding cage that is disposed in the communication facility in a pluggable manner. In order to define the electrical-to-mechanical interface of the optical transceiver and the corresponding cage, different specifications have been provided such as XFP (10 Gigabit Small Form Factor Pluggable) used in 10 GB/s communication rate and QSFP (Quad Small Form-factor Pluggable).

In the optical transceiver, a fiber connector, such as MT-type ferrule connector, is used to retain multiple optical fibers in a fixed position within a fiber passageway, and the fiber connector is always held by its respective housing.

### SUMMARY

According to one aspect of the present disclosure, an optical transceiver includes a substrate, a housing, a ferrule and a fixture. The housing is disposed on an outer surface of the substrate and includes a pressed portion and an inset portion connected to each other. The pressed portion defines a first pressed surface, and the ferrule is disposed on the inset portion. The fixture is disposed on the housing, a first pressing surface of the fixture is pressed against the first pressed surface of the housing, and a second pressing surface of the fixture is pressed against a second pressed surface of the ferrule. The fixture detached from the housing is in a force-free condition, and a distance between the first pressing surface and the second pressing surface in the force-free condition is smaller than a distance between the first pressed surface and the second pressed surface.

According to another aspect of the present disclosure, an optical transceiver includes a substrate, a housing and a ferrule. The housing is disposed on an outer surface of the substrate and includes a main body and an arm connected to each other. The main body defines an accommodation groove and an opening connected to each other, and a blocking surface of the main body in the accommodation groove facing the opening. The arm extends along a direction away from the main body, and a pressing surface of the arm faces the main body. The ferrule is disposed in the accommodation groove through the opening. A mating surface of the ferrule is pressed against the blocking surface of the housing, and the pressing surface of the housing is pressed against a pressed surface of the ferrule. The housing without accommodating the ferrule is in a force-free condition, and a distance between the pressing surface and the blocking surface in the force-free condition is smaller than a distance between the pressed surface and the mating surface.

According to still another aspect of the present disclosure, an optical transceiver includes a substrate, a housing, a ferrule and a fixture. The housing is disposed on an outer surface of the substrate. The ferrule is disposed on the housing. The fixture is disposed on the housing, and an interference fit is presented among the housing, the ferrule and the fixture.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1A is a perspective view of an optical transceiver according to a first embodiment of the present disclosure;

FIG. 1B is an exploded view of the optical transceiver in FIG. 1A;

FIG. 1C is a top view of the optical transceiver in FIG. 1A with a fixture detached from a housing of the optical transceiver;

FIG. 1D is a top view of the optical transceiver in FIG. 1A with the fixture disposed on the housing;

FIG. 1E is a side view of the optical transceiver in FIG. 1D;

FIG. 2A is a perspective view of an optical transceiver according to a second embodiment of the present disclosure;

FIG. 2B is an exploded view of the optical transceiver in FIG. 2A;

FIG. 2C is a top view of the optical transceiver in FIG. 2A with a ferrule detached from a housing;

FIG. 2D is a top view of the optical transceiver in FIG. 2A with the ferrule disposed on the housing; and

FIG. 2E is a cross-sectional view of the optical transceiver in FIG. 2D.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

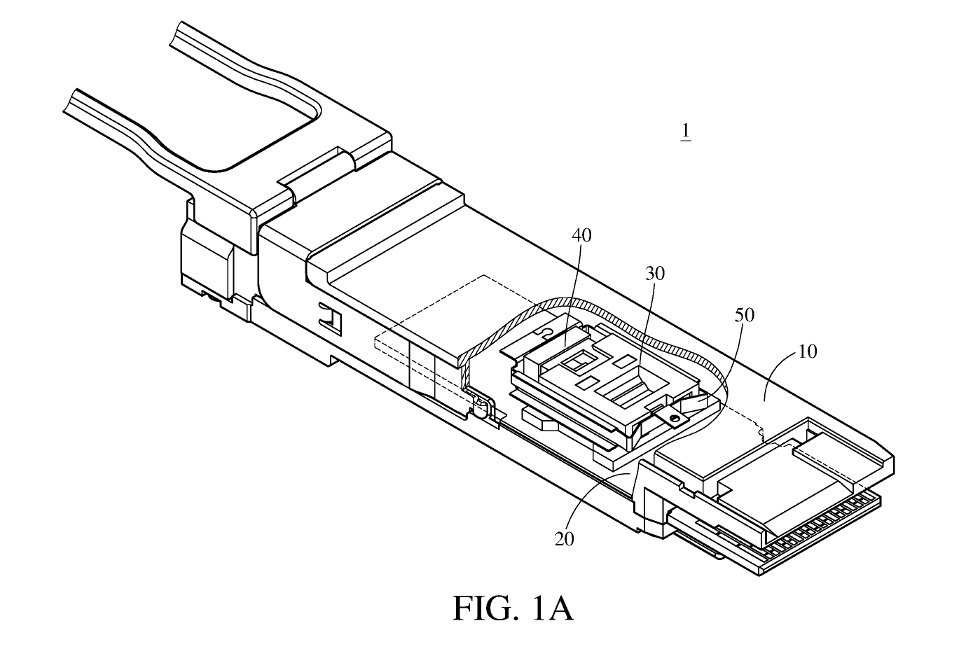

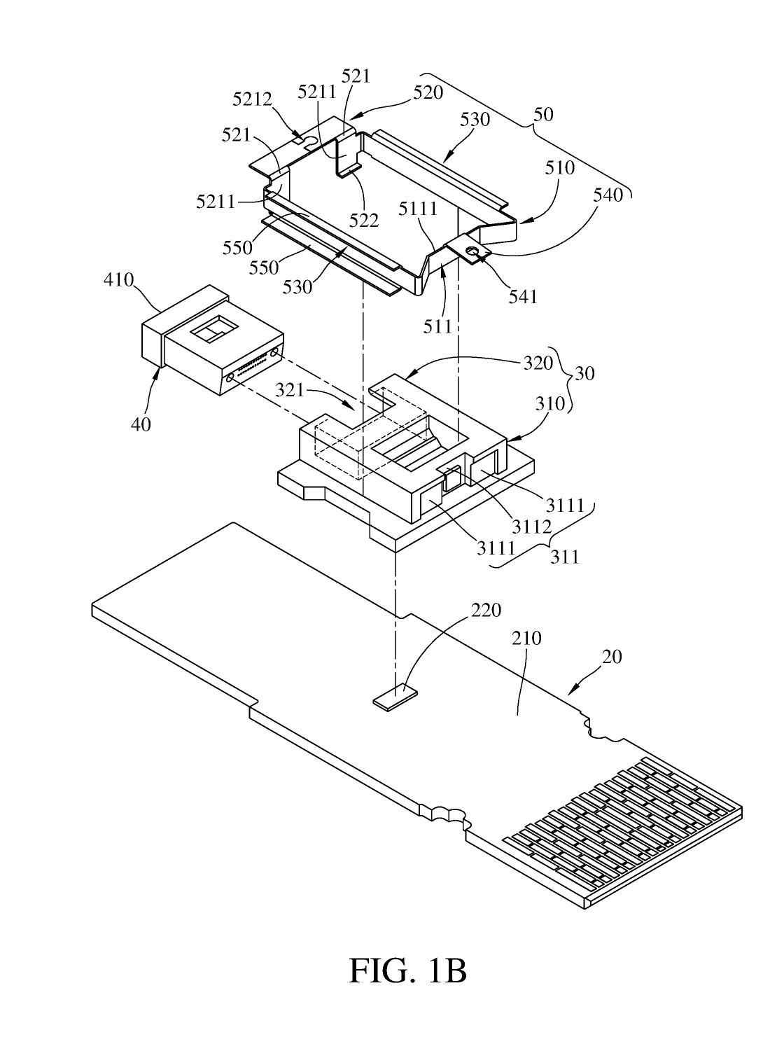

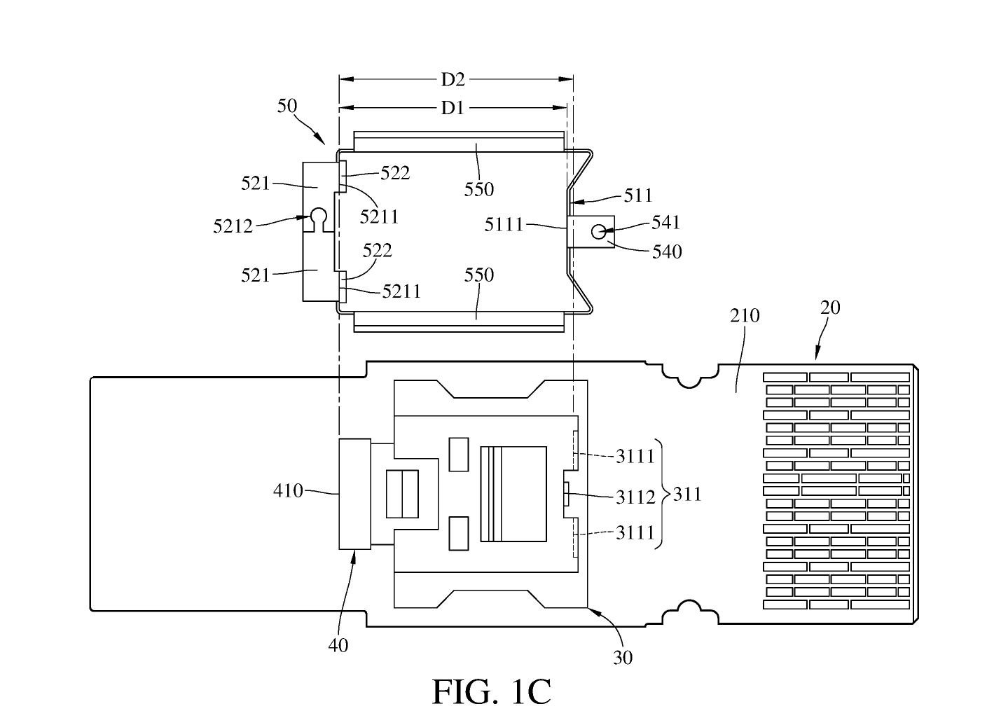

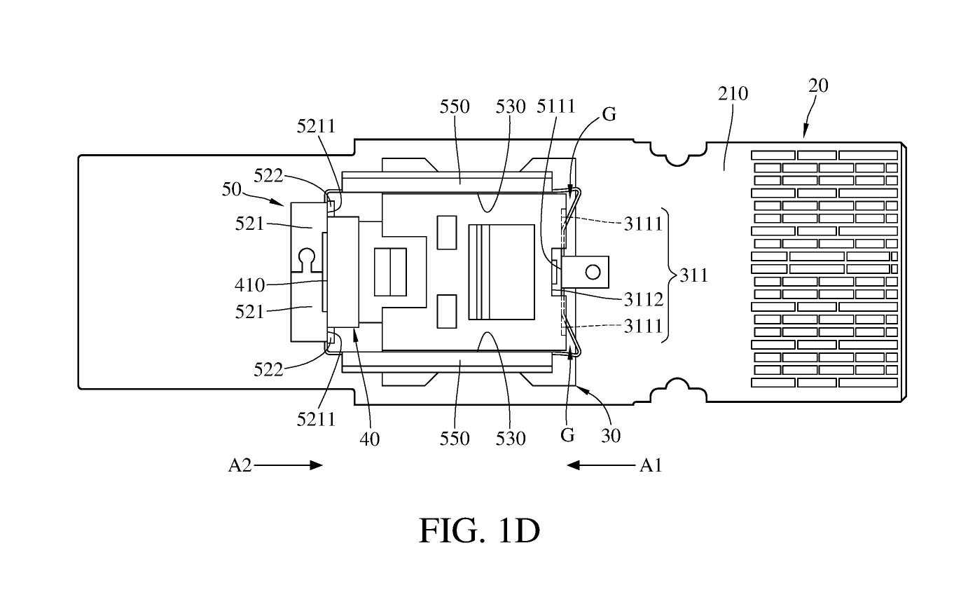

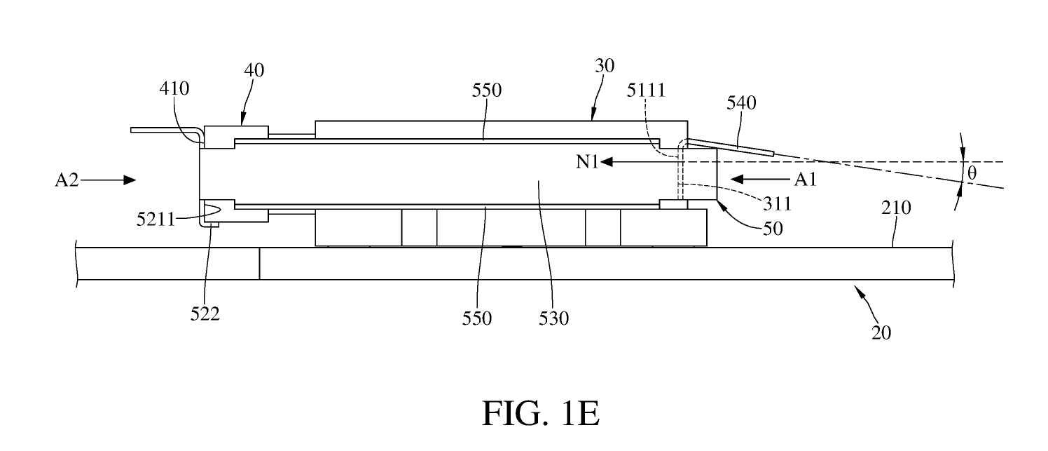

Please refer to FIG. 1A to FIG. 1E. FIG. 1A is a perspective view of an optical transceiver according to a first embodiment of the present disclosure. FIG. 1B is an exploded view of the optical transceiver in FIG. 1A. FIG. 1C is a top view of the optical transceiver in FIG. 1A with a fixture detached from a housing of the optical transceiver. FIG. 1D is a top view of the optical transceiver in FIG. 1A with the fixture disposed on the housing. FIG. 1E is a side view of the optical transceiver in FIG. 1D. In this embodiment, an optical transceiver 1 is disclosed, and the optical transceiver 1 includes a case 10, a substrate 20, a housing 30, a ferrule 40 and a fixture 50.

The case 10, for example, is made of metal. The substrate 20, for example, is a circuit board or a package substrate disposed in the case 10. For the purpose of illustration, the case 10 is omitted in FIG. 1B through FIG. 1E.

The housing 30 is disposed on an outer surface 210 of the substrate 20. The housing 30 includes a pressed portion 310 and an inset portion 320 connected to each other. The pressed portion 310 defines a first pressed surface 311, and the inset portion 320 defines an accommodation groove 321. In this embodiment, the first pressed surface 311 is a non-flat surface which includes two planar sections 3111 and a recessed section 3112 located between the two flat sections 3111, but the present disclosure is not limited thereto. In some embodiments, the first pressed surface is a flat surface.

The ferrule 40, for example, is a MT-type connector ferrule for holding optical fibers, and the ferrule 40 is disposed on the inset portion 320. In detail, the ferrule 40 is inserted into the accommodation groove 321. The housing 30 may include a fiber array which is used to couple the optical fibers to an active component 220, such as a laser diode or a photodiode. When the active component 220 receives optical signals, the optical signals could be transmitted to an IC chip (not shown in the drawings) and converted into electrical signals. The ferrule 40 defines a second pressed surface 410 located on a side of the ferrule 40 away from the accommodation groove 321.

The fixture 50, for example, is a metal sheet with flexibility. The fixture 50 is disposed on the housing 30 and includes a first pressing portion 510, a second pressing portion 520, two arms 530 and an extension portion 540 connected to each other. The first pressing portion 510 is located near the pressed portion 310 of the housing 30 and includes a recessed structure 511. The recessed structure 511 defines a first pressing surface 5111 pressed against the two planar sections 3111 of the first pressed surface 311.

The second pressing portion 520 is located near the ferrule 40. The second pressing portion 520 includes two pressing parts 521, and each of the two pressing parts 521 define a second pressing surface 5211 which is pressed against the second pressed surface 410 of the ferrule 40. The two pressing parts 521 are fasten-able to each other to be at either a fastening state or an unfastening state. In this embodiment, the two pressing parts 521 are fastened together by a male-female mating structure 5212. When the two pressing parts 521 are at the fastening state, the two pressing parts 521 are assembled together so that the fixture 50 is able to be securely positioned on the housing 30. The two pressing parts 521 are able to be unfastened into the unfastening state. When the two pressing parts 521 are at the unfastening state, the two pressing parts 521 are separated from each other to release the fixture 50. It is worth nothing that the protective scope of the present disclosure is not limited to the number of the pressing parts 521 and the number of the second pressing surfaces 5211.

The two arms 530 are located between the first pressing portion 510 and second pressing portion 520. In other words, the first pressing portion 510 and second pressing portion 520 are connected to each other via the two arms 530. As shown in FIG. 1D, when the fixture 50 is disposed on the housing 30, the first pressing portion 510, the second pressing portion 520 and the two arms 530 jointly surrounds the housing 30 and the ferrule 40. The extension portion 540 is located on a side of the first pressing portion 510 away from the first pressed surface 311 of the housing 30, and the extension portion 540 defines a hole 541. It is worth nothing that the protective scope of the present disclosure is not limited to the extension portion 540.

In this embodiment, the fixture 50 is detachable from the housing 30. In detail, the pressing parts 521 may be unfastened for the fixture 50 to be released. The fixture 50 when detached from the housing 30 is in a force-free condition, which has no force interaction with both the housing 30 and the ferrule 40. As shown in FIG. 1C, when the fixture 50 is in the force-free condition, the distance D1 between the first pressing surface 5111 and the second pressing surface 5211 of the fixture 50 is smaller than the distance D2 between the first pressed surface 311 of the housing 30 and the second pressed surface 410 of the ferrule 40.

As shown in FIG. 1D and FIG. 1E, the fixture 50, which is securely positioned on the housing 30, could be with the force interaction with both the housing 30 and the ferrule 40. In detail, since the distance D1 between the first pressing surface 5111 and the second pressing surface 5211 in the force-free condition is smaller than the distance D2 between the first pressed surface 311 and the second pressed surface 410, an interference fit is presented among the housing 30, the ferrule 40 and the fixture 50 when the fixture 50 is disposed on the housing 30. More specifically, the interference fit is achieved with the first pressing surface 5111 exerting a press force upon the first pressed surface 311 in a direction Al as well as the second pressing surfaces 5211 exerting a press force upon the second pressed surface 410 in a direction A2.

In a conventional optical transceiver, the ferrule when disposed within the housing does not often stay at its expected position due to the external force, and thus the coupling efficiency between the active component and the optical fibers in the ferrule may be seriously and negatively affected. To solve this problem, a fixture 50 is provided in this embodiment to optimize the mating of the ferrule 40. When the fixture 50 is disposed on the housing 30, the interference fit among the housing 30, the ferrule 40 and the fixture 50 could help minimize the occurrence of the ferrule 40 not staying in its expected position.

Referring to FIG. 1D, the fixture 50 includes the recessed structure 511 in this embodiment when multiple gaps G present between the housing 30 and the first pressing portion 510. Therefore, only the first pressing surface 5111 is pressed against the housing 30, and the rest of the first pressing portion 510 is spaced apart from the housing 30 to prevent friction between them and thus enable the fixture 50 to be detached without too much difficulty. It is worth nothing that the protective scope of the present disclosure is not limited to the recessed structure 511. In some embodiments, the fixture 50 does not include any recessed structure 511, and the entire first pressing portion 511 of the fixture 50 is pressed against the housing.

Referring to FIG. 1E, there is an acute angle 0 between an extension direction of the extension portion 540 and the normal line Ni of the first pressing surface 5111 in this embodiment. Therefore, it is favorable for increasing the torque generated by the force applied on the extension portion 540 so as to provide leverage. As such, for the fixture 50 to be lifted only relatively small amount of force may be necessary. The acute angle 0 is greater than or equal to 5.0 degrees and less than or equal to 30.0 degrees in one embodiment. If the acute angle θ is less than 5.0 degrees, the increase of the torque is insufficient to provide the necessary leverage. If the acute angle θ is greater than 30.0 degrees, an end of the extension portion 540 is overly close to the outer surface 210, increasing the likelihood of the substrate 20 being accidentally damaged.

Moreover, the second pressing portion 520 of the fixture 50 includes two supporting parts 522 respectively connected to the two pressing parts 521 in this embodiment, and the ferrule 40 is supported by the two supporting parts 522 when the fixture 50 is disposed on the housing 30. Therefore, the ferrule 40 could be prevented from dropping because of its own weight.

Referring to FIG. 1B, the fixture 50 includes a plurality of strengthening ribs 550 connected to the arms 530 in this embodiment. Therefore, it is favorable for preventing the fixture 50 from damage or unfavorable deformation.

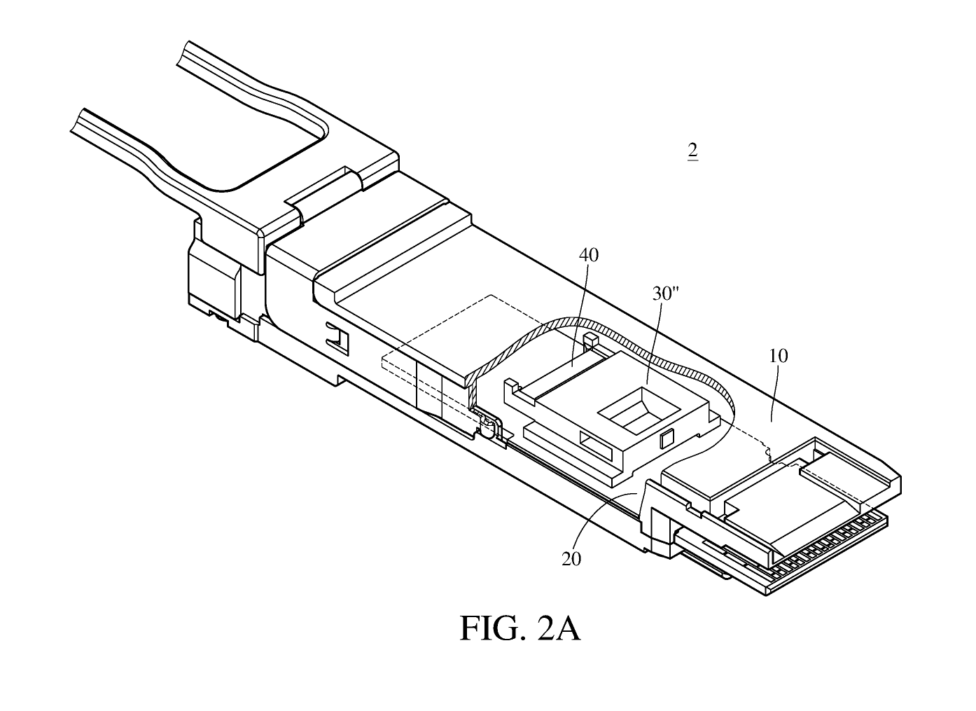

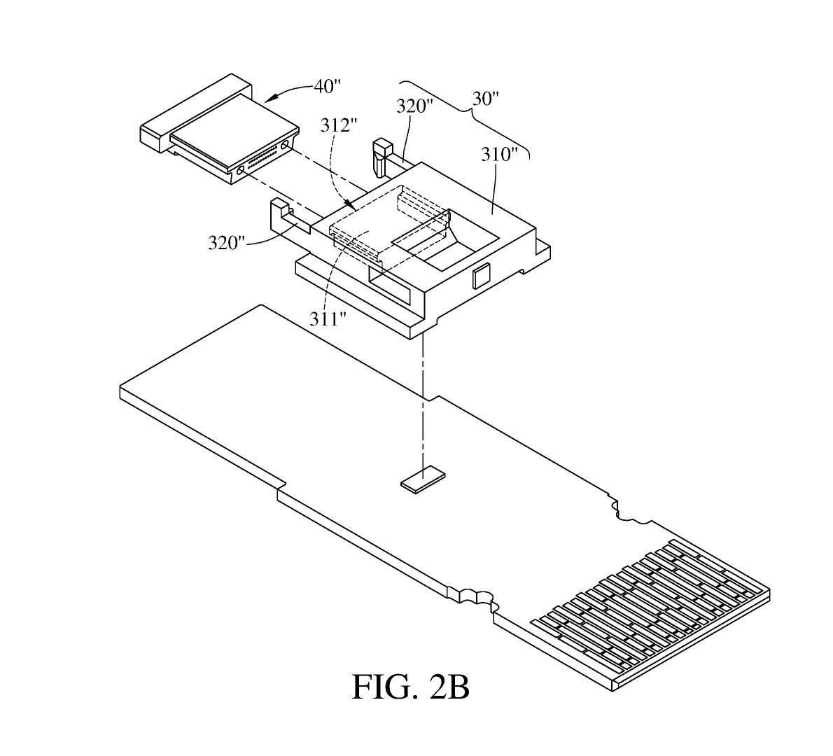

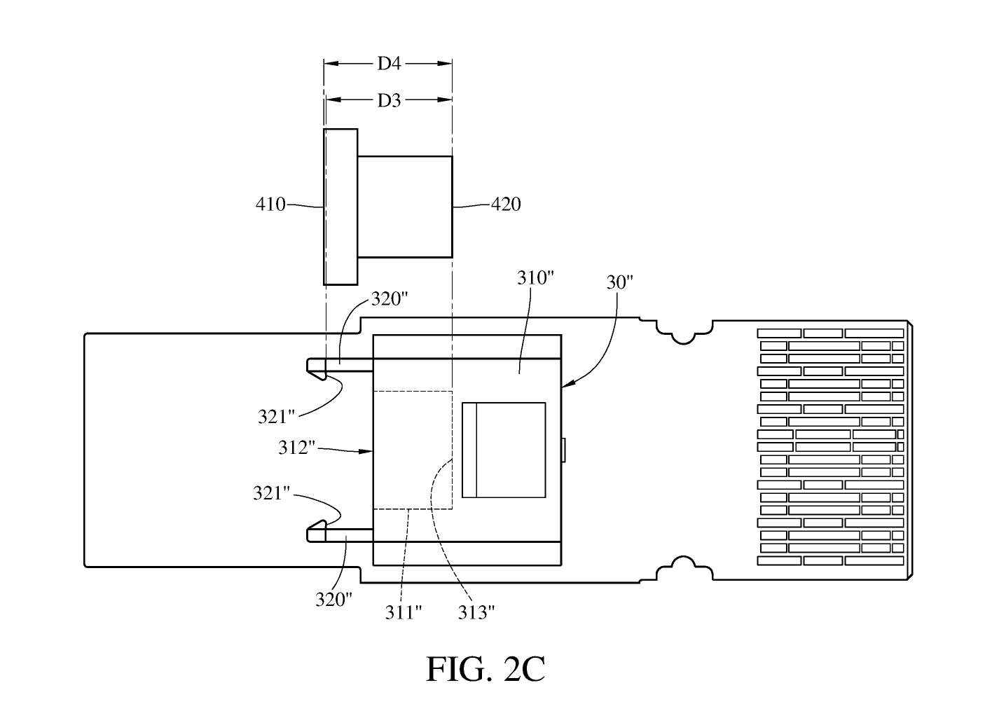

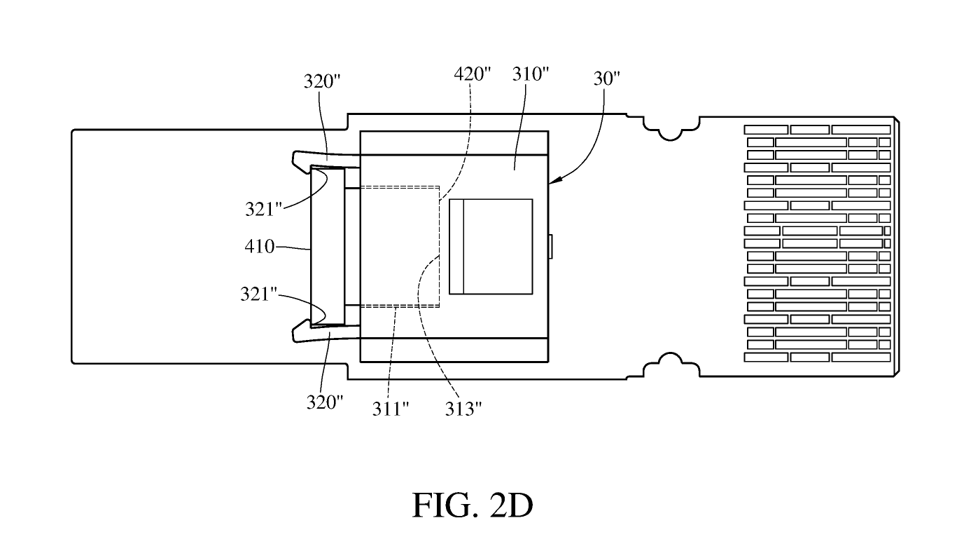

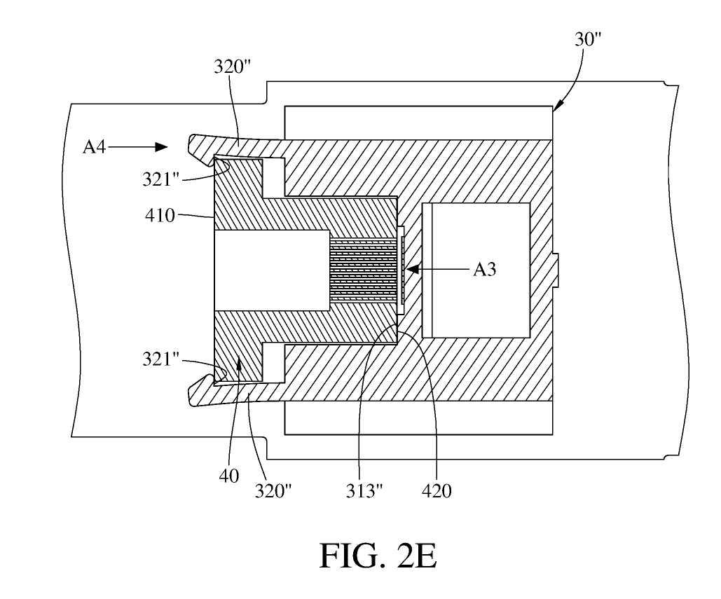

Please refer to FIG. 2A to FIG. 2E, wherein another aspect of the present disclosure provides a configuration of the housing for holding the ferrule. FIG. 2A is a perspective view of an optical transceiver according to a second embodiment of the present disclosure. FIG. 2B is an exploded view of the optical transceiver in FIG. 2A. FIG. 2C is a top view of the optical transceiver in FIG. 2A with a ferrule detached from a housing. FIG. 2D is a top view of the optical transceiver in FIG. 2A with the ferrule disposed on the housing. FIG. 2E is a cross-sectional view of the optical transceiver in FIG. 2D. In this embodiment, an optical transceiver 2 is disclosed, and the optical transceiver 2 includes a case 10, a substrate 20, a housing 30″ and a ferrule 40. The case 10, the substrate 20 and the ferrule 40 are similar to their counterparts in the first embodiment. For the purpose of illustration, the case 10 is omitted in FIG. 2B through FIG. 2E.

The housing 30″ includes a main body 310″ and two arms 320″ connected to each other. The main body 310″ defines an accommodation groove 311″ and an opening 312″ connected to each other. The main body 310″ further defines a blocking surface 313″ located in the accommodation groove 311″, and the blocking surface 313″ faces the opening 312″. Each of the two arms 320″ extends along a direction away from the main body 310″, and each arm 320″ defines a pressing surface 321″ facing the main body 310″. In this embodiment, the arms 320″ are integral with the main body 310″ and are all made of flexible material.

The ferrule 40 is disposed in the accommodation groove 311″ through the opening 312″. Referring to FIG. 2E, a mating surface 420 of the ferrule 40 is pressed against the blocking surface 313″ of the housing 30″, and the pressing surfaces 321″ of the housing 30″ are pressed against the pressed surface 410 of the ferrule 40.

In this embodiment, when the ferrule 40 is removed from the accommodation groove 311″, there is no force interaction between the housing 30″ and the ferrule 40. The housing 30″, without accommodating the ferrule 40, is in a force-free condition. As shown in FIG. 2C, when the housing 30″ is in the force-free condition, the distance D3 between the pressing surface 321″ and the blocking surface 313″ of the housing 30″ is smaller than the distance D4 between the pressed surface 410 and the mating surface 420 of the ferrule 40. Therefore, when the ferrule 40 is disposed in the accommodation groove 311″, there is an interference fit between the housing 30″ and the ferrule 40. More specifically, the interference fit is achieved with the blocking surface 313″ exerting a press force upon the mating surface 420 in a direction A3 as well as the pressing surfaces 321″ exerting a press force upon the pressed surface 410 in a direction A4.

According to one aspect of the present disclosure, the fixture, which is detached from the housing, is in the force-free condition. The distance between the first pressing surface and the second pressing surface of the fixture in the force-free condition is smaller than the distance between the first pressed surface of the housing and the second pressed surface of the ferrule. Therefore, when the fixture is disposed on the housing, the interference fit among the housing, the ferrule and the fixture is favorable for holding the ferrule to minimize the occurrence of the ferrule of not staying in its expected position and therefore optimize the mating of the ferrule.

Furthermore, according to another aspect of the present disclosure, the housing, without accommodating the ferrule, is in the force-free condition. The distance between the pressing surface and the blocking surface of the housing in the force-free condition is smaller than the distance between the pressed surface and the mating surface of the ferrule. Therefore, when the ferrule is disposed in the accommodation groove of the housing, the interference fit between the arm of the housing and the ferrule is favorable for holding the ferrule so that the ferrule may often stay in its expected position.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

1. An optical transceiver, comprising:
a substrate;
a housing disposed on an outer surface of the substrate, the housing comprising a pressed portion and an inset portion connected to each other, and the pressed portion defining a first pressed surface;
a ferrule disposed on the inset portion; and
a fixture disposed on the housing, the fixture including a first pressing surface of the fixture being pressed against the first pressed surface of the housing, and a second pressing surface of the fixture being pressed against a second pressed surface of the ferrule, wherein the fixture comprises a first pressing portion and a second pressing portion connected to each other, the first pressing portion defines the first pressing surface, the second pressing portion comprises two pressing parts, each of the two pressing parts defines the second pressing surface, and the two pressing parts are fastenable to each other;
wherein the fixture detached from the housing is in a force-free condition, the force-free condition including a distance between the first pressing surface and the second pressing surface being smaller than a distance between the first pressed surface and the second pressed surface.

2. The optical transceiver according to claim 1, wherein an interference fit is presented among the housing, the ferrule and the fixture.

3. The optical transceiver according to claim 1, wherein the fixture comprises a first pressing portion, a second pressing portion and an extension portion connected to each other, the first pressing portion defines the first pressing surface, the second pressing portion defines the second pressing surface, and the extension portion is located on a side of the first pressing portion away from the first pressed surface.

4. The optical transceiver according to claim 3, wherein the extension portion of the fixture extends along an extension direction with an acute angle between the extension direction and a normal line of the first pressing surface.

5. The optical transceiver according to claim 4, wherein the acute angle is greater than or equal to 5.0 degrees and less than or equal to 30.0 degrees.

6. (canceled)

7. The optical transceiver according to claim 6, wherein the second pressing portion of the fixture further comprises two supporting parts respectively connected to the two pressing parts, and the ferrule is supported by the two supporting parts.

8. The optical transceiver according to claim 1, wherein the fixture comprises a plurality of strengthening ribs.

9. The optical transceiver according to claim 1, wherein the fixture comprises a first pressing portion and a second pressing portion connected to each other, the first pressing portion comprises a recessed structure, the recessed structure defines the first pressing surface, and the second pressing portion defines the second pressing surface.

10. An optical transceiver, comprising:
a substrate;
a housing disposed on an outer surface of the substrate, the housing comprising a main body and an arm connected to each other, the main body defining an accommodation groove and an opening connected to each other, a blocking surface of the main body in the accommodation groove facing the opening, the arm extending along a direction away from the main body, and a pressing surface of the arm facing the main body, wherein the main body and the arm are integrally formed as single piece; and
a ferrule disposed in the accommodation groove through the opening, a mating surface of the ferrule being pressed against the blocking surface of the housing, and the pressing surface of the housing being pressed against a pressed surface of the ferrule;
wherein the housing without accommodating the ferrule is in a force-free condition, a distance between the pressing surface and the blocking surface in the force-free condition is smaller than a distance between the pressed surface and the mating surface.

11. The optical transceiver according to claim 10, wherein the arm and main body are made of a same flexible material.

12. (canceled)

13. An optical transceiver, comprising:
a substrate;
a housing disposed on an outer surface of the substrate;
a ferrule disposed on the housing; and
a fixture disposed on the housing, wherein an interference fit is presented among the housing, the ferrule and the fixture:,
wherein the fixture comprises a first pressing portion and a second pressing portion connected to each other, the first pressing portion is pressed against the housing, the second pressing portion comprises two pressing parts which are pressed against the ferrule, and the two pressing parts are fastenable to each other.

14. The optical transceiver according to claim 13, wherein the fixture comprises a first pressing portion, a second pressing portion and an extension portion connected to each other, the first pressing portion is pressed against the housing, the second pressing portion is pressed against the ferrule, and the extension portion is located on a side of the first pressing portion.

15. (canceled)

16. The optical transceiver according to claim 13, wherein the fixture comprises a recessed structure pressed against the housing.

17. The optical transceiver of claim 1, wherein the two pressing parts fasten together based on a male-female mating structure.

18. The optical transceiver of claim 1, wherein unfastening the two pressing parts allows the two pressing parts to be separated from each other to release the fixture from the housing.
